(19) United States
(12) Patent Application Publication
(10) Pub. No.: US 2026/0104662 A1
(43) Pub. Date: Apr. 16, 2026

(54) IMAGE FORMING APPARATUS

(71) Applicant: CANON KABUSHIKI KAISHA, Tokyo (JP)

(72) Inventor: TOSHIYUKI KUROSU, Ibaraki (JP)

(21) Appl. No.: 19/349,341

(22) Filed: Oct. 3, 2025

(30) Foreign Application Priority Data
Oct. 16, 2024 (JP) 2024-180802

(51) Int. Cl. G03G 15/16; G03G 15/00; G03G 15/01

(52) U.S. Cl. CPC G03G 15/1615; G03G 15/0131; G03G 15/0189; G03G 15/167; G03G 15/80

(57) ABSTRACT

An image forming apparatus includes a backup member configured to come into contact with an inner surface of an intermediate transfer belt upstream of a secondary transfer unit, a backup member holding member configured to hold the backup member, and an insulating sheet disposed to cover a downstream end of the backup member holding member in a conveyance direction of the intermediate transfer belt.

### BACKGROUND

### Field of the Technology

The present disclosure relates to an intermediate transfer-type image forming apparatus.

### Description of the Related Art

To transfer a toner image formed on an intermediate transfer belt to a recording medium with high precision, the contact length between the intermediate transfer belt and a recording medium upstream of a secondary transfer unit is important. If the contact length is long, image defects may be caused by the toner rubbing against the recording medium due to the speed difference between the belt and the recording medium. On the other hand, if the contact length is short, image defects may be caused by abnormal electric discharge due to the gap between the recording medium and the belt. For this reason, the conveyance posture of the recording medium and the stretch layout of the intermediate transfer belt are determined taking into account the contact position of the recording medium with the belt upstream of the secondary transfer unit.

Japanese Patent Laid-Open No. 9-80926 discusses a configuration in which a flat correction member (backup member) made of a flexible plate is provided on the inner surface of the belt upstream of the tacking position between the intermediate transfer belt and the recording medium, to suppress undulation that may occur upstream of the secondary transfer unit and suppress electric discharge due to the gap between the intermediate transfer belt and the recording medium, thereby providing high-quality output.

Japanese Patent Laid-Open No. 2015-210313 discusses the length L along the belt surface between the downstream end of the portion of the backup member that contacts the intermediate transfer belt and the upstream end of the transfer nip portion, with respect to a rotation direction of the intermediate transfer belt. That is, a configuration is discussed in which the length L is made shorter than the length of the margin outside the image formation area at the upstream end of the surface of the recording medium. This makes it possible to prevent image defects from becoming apparent on the recording medium, even in the case of using recording media with high bending rigidity, such as thick paper or coated paper. That is, it is possible to suppress image defects caused by abnormal electric discharge that can result from separation of the recording medium and the intermediate transfer belt due to pressure from the recording medium.

A high voltage for secondary transfer is applied to the secondary transfer unit. In recent years, there has been a demand for improved productivity in the use of recording media with high bending rigidity, such as thick paper and coated paper. This has created a need to increase the high voltage capacity applied to the secondary transfer unit in order to maintain transferability even when the conveyance speed is increased. As described above, the backup member needs to be arranged close to the secondary transfer unit to prevent image defects caused by friction between the toner and the recording medium and abnormal electric discharge that may occur due to the gap between the recording medium and the intermediate transfer belt.

The backup member itself is made of a flexible insulating resin material, but a backup member holding member that holds the backup member is made of a metal material to ensure the rigidity of the backup member. Furthermore, the metallic backup member holding member is grounded to suppress noise generation. For this reason, if an attempt is made to place the backup member close to the secondary transfer unit, a sufficient creepage distance cannot be secured between the secondary transfer unit and the backup member holding member, resulting in a problem of secondary transfer voltage leaking to the backup member holding member.

### SUMMARY

The present disclosure is directed to suppressing leakage of the secondary transfer voltage from the secondary transfer unit to the backup member holding member.

An aspect of the present disclosure provides an image forming apparatus that includes an intermediate transfer belt onto which a toner image is to be transferred; an inner roller configured to stretch the intermediate transfer belt; an outer roller configured to sandwich the intermediate transfer belt between the outer roller and the inner roller to form a transfer nip to transfer the toner image formed on the intermediate transfer belt onto a recording medium; a backup member configured to contact an inner surface of the intermediate transfer belt upstream of the transfer nip in a conveyance direction of the intermediate transfer belt; a holding member configured to hold the backup member such that a downstream end of the backup member is arranged downstream of an upstream end in the conveyance direction of the intermediate transfer belt and the downstream end of the backup member is in contact with the intermediate transfer belt; and an insulating member configured to cover the downstream end of the holding member with respect to the conveyance direction of the intermediate transfer belt, and to cover the holding member from one end of the holding member to an other end in a width direction orthogonal to the conveyance direction.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic cross-sectional view of an image forming apparatus.

FIG. 2A is a schematic cross-sectional view of a secondary transfer unit before a recording medium moves to the secondary transfer unit.

FIG. 2B is a schematic cross-sectional view of the secondary transfer unit after the recording medium has moved to the secondary transfer unit.

FIG. 2C is an enlarged view of the secondary transfer unit in FIG. 2B.

FIG. 3A is a schematic cross-sectional view of the secondary transfer unit including an insulating member according to an embodiment.

FIG. 3B is a schematic cross-sectional view of a secondary transfer unit having a conventional configuration.

FIG. 4A is a longitudinal schematic view of the secondary transfer unit including the insulating member according to the embodiment.

FIG. 4B is a schematic cross-sectional view of the secondary transfer unit having the conventional configuration.

### DESCRIPTION OF THE EMBODIMENTS

### First Embodiment

Hereinafter, embodiments of the present disclosure will be described with reference to the drawings. However, the present disclosure is not limited to the following embodiments.

### Configuration of Image Forming Apparatus

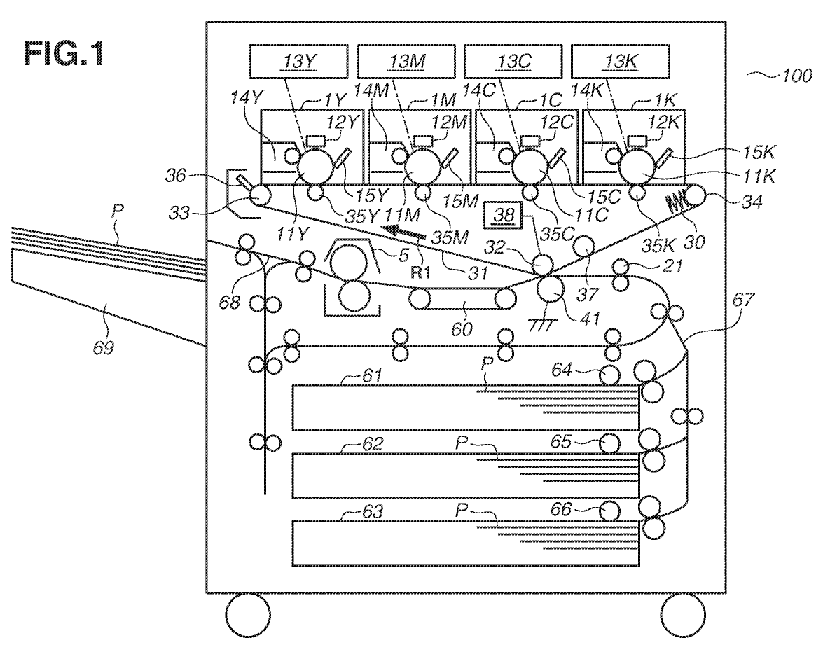

FIG. 1 is a schematic cross-sectional view of an image forming apparatus 100. The image forming apparatus 100 is a tandem intermediate transfer-type image forming apparatus in which image forming units 1Y, 1M, 1C, and 1K are arranged in series on the horizontal portion of an intermediate transfer belt 31. The image forming apparatus 100 forms a full-color image on a recording medium P by electrophotography in response to an image signal transmitted from an external device.

The image forming units 1Y, 1M, 1C, and 1K form yellow, magenta, cyan, and black toner images on photosensitive drums 11Y, 11M, 11C, and 11K, respectively, and primarily transfer the toner images to the same image positions on the intermediate transfer belt 31. The intermediate transfer belt 31 is stretched by a drive roller 33, a tension roller 34, and an inner secondary transfer roller 32 for performing secondary transfer, and rotates in the (clockwise) rotation direction R1. Primary transfer rollers 35Y, 35M, 35C, and 35K for performing primary transfer are arranged on the inner peripheral surface of the intermediate transfer belt 31 at positions facing photosensitive drums 11Y, 11M, 11C, and 11K, respectively.

Around the photosensitive drum 11Y on which a yellow toner image is to be formed, there are arranged a charger 12Y that uniformly charges the surface of the photosensitive drum 11Y, and an exposure device 13Y that irradiates the photosensitive drum 11Y with image light to form a latent image on the surface. There are also arranged a development device 14Y that transfers toner to the latent image on the photosensitive drum 11Y to form a toner image, and a cleaning device 15Y that removes toner remaining on the photosensitive drum 11Y after the primary transfer of the toner image. The configurations for forming magenta, cyan, and black toner images can be understood by replacing the suffix Y in the above description with M, C, and K.

Meanwhile, the recording media P stored in paper feed cassettes 61, 62, and 63 are conveyed to a paper feed conveyance path 67 by the rotation of one of paper feed rollers 64, 65, and 66. Registration rollers 21 feed the recording media P to the secondary transfer unit in synchronization with the toner image on the intermediate transfer belt 31. The secondary transfer unit is formed by an outer secondary transfer roller 41 (outer roller) and the inner secondary transfer roller 32 (inner roller) sandwiching the recording media P therebetween, and the toner image is secondarily transferred onto the recording media P at the secondary transfer unit.

Residual toner remaining on the intermediate transfer belt 31 after the secondary transfer is removed by a cleaning device 36.

Next, the recording medium P onto which the toner image has been transferred is conveyed by a conveyance belt 60 to a thermal fixing device 5, and the toner image is fixed to the surface of the recording medium P by the thermal fixing device 5 heating and pressing the recording medium P. Accordingly, the full-color image is fixed onto the recording medium P, and the recording medium P is sent to a paper discharge tray 69 through a paper discharge conveyance path 68.

### Secondary Transfer Unit

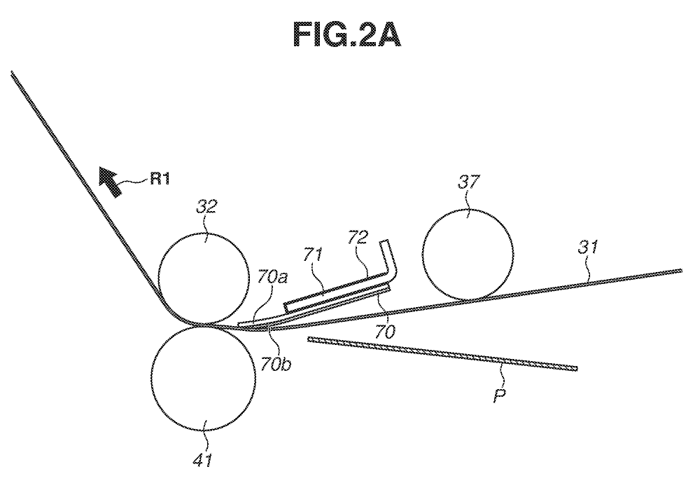

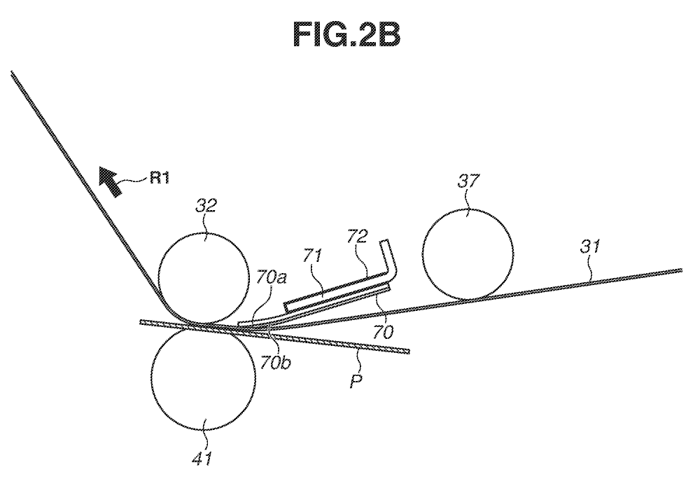

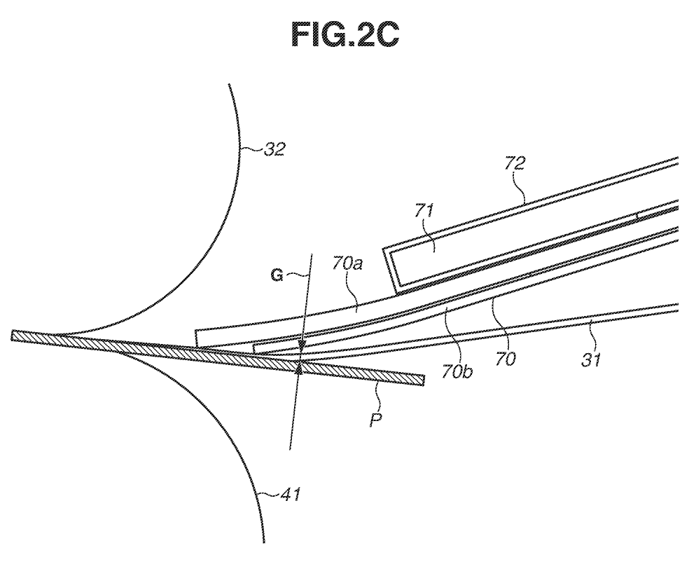

FIG. 2A is a schematic cross-sectional view of the secondary transfer unit before the recording medium P moves to the secondary transfer unit, FIG. 2B is a schematic cross-sectional view of the secondary transfer unit after the recording medium P has moved to the secondary transfer unit, and FIG. 2C is an enlarged view of the secondary transfer unit in FIG. 2B.

As illustrated in FIGS. 2A-2C, with respect to the shape of the intermediate transfer belt 31 formed by being stretched by the inner secondary transfer roller 32 and the pre-secondary transfer roller 37, the outer secondary transfer roller 41 is elastically biased toward the inner secondary transfer roller 32 by an elastic spring. Accordingly, the intermediate transfer belt 31 is sandwiched between the inner secondary transfer roller 32 and the outer secondary transfer roller 41 to form the secondary transfer unit. Upstream of the secondary transfer unit in a rotation direction R1 of the intermediate transfer belt 31, a backup member 70 is arranged in proximity to the inner secondary transfer roller 32 via a backup member holding member 71. The inner surface of the intermediate transfer belt 31 and the leading end of the backup member 70 are in contact with each other. That is, the backup member 70 is held by the backup member holding member 71 such that its downstream end is in contact with the inner surface of the intermediate transfer belt 31 in the conveyance direction of the intermediate transfer belt 31. In the present embodiment, the backup member 70 is made of a PET material 70a with a thickness of 0.5 mm and an insulating resin material PET 70b with a thickness of 0.25 mm thick. The backup member 70 elastically biases the intermediate transfer belt 31 by its flexural elasticity. The backup member 70 is statically determinate at a position where the biasing force of the backup member 70 biasing the intermediate transfer belt 31 balances with the normal force generated by the tension of the intermediate transfer belt 31. The statically determinate position of the backup member 70 determines the shape of the intermediate transfer belt 31 upstream of the secondary transfer unit. A bias voltage of the same polarity as the charge polarity of the toner of the toner image on the intermediate transfer belt 31 is applied to the inner secondary transfer roller 32 by a secondary transfer high-voltage power supply 38. The outer secondary transfer roller 41 is grounded, thereby forming a transfer field in the secondary transfer unit. The recording medium P is guided by a pre-secondary transfer guide and conveyed to the secondary transfer unit where the transfer field is formed. At this time, the intermediate transfer belt 31 upstream of the secondary transfer unit comes into contact with the recording medium P, and the recording medium P is further conveyed toward the secondary transfer unit in a state where the toner image formed on the surface of the intermediate transfer belt 31 is in contact with the recording medium P. The recording medium P is conveyed to the secondary transfer unit, where the toner image is transferred from the intermediate transfer belt 31 to the recording medium P by the pressure action between the inner secondary transfer roller 32 and the outer secondary transfer roller 41 and the electrical action of the transfer field. If the contact length between the intermediate transfer belt 31 upstream of the secondary transfer unit and the recording medium P is short during conveyance of the recording medium P to the secondary transfer unit, a gap G between the intermediate transfer belt 31 and the recording medium P increases, resulting in image defects due to an electric discharge phenomenon. On the other hand, if the contact length between the intermediate transfer belt 31 and the recording medium P is long, image defects are caused by friction between the toner image formed on the surface of the intermediate transfer belt 31 and the recording medium P. Optimizing the contact length between the intermediate transfer belt 31 and the recording medium P enables stable secondary transfer of the toner image to the recording medium P.

The image forming apparatus 100 of the present embodiment is an apparatus that achieves high productivity, the intermediate transfer belt 31 is rotated at a speed of 600 mm/s, and the toner has a negative polarity. To ensure transfer performance even at this speed, a high voltage bias of −14 kV is applied to the inner secondary transfer roller 32, but the toner polarity and voltage value are not limited to this example.

In the present embodiment, the backup member 70 is made of a PET material with a thickness of 0.5 mm and a PET material with a thickness of 0.25 mm, but the configuration is not limited to this example and any material can be used as long as it can elastically bias the intermediate transfer belt 31. For example, the backup member 70 may be 1.0 mm thick, and may be made of PEEK, PPS, or the like.

### Configuration of Insulating Member

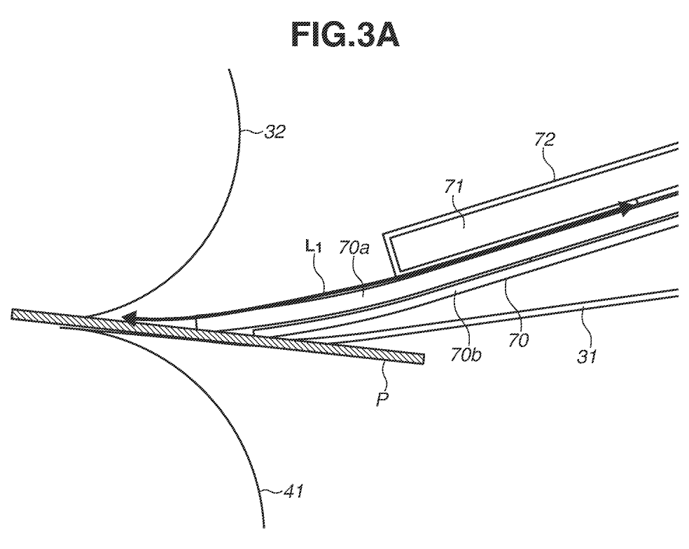

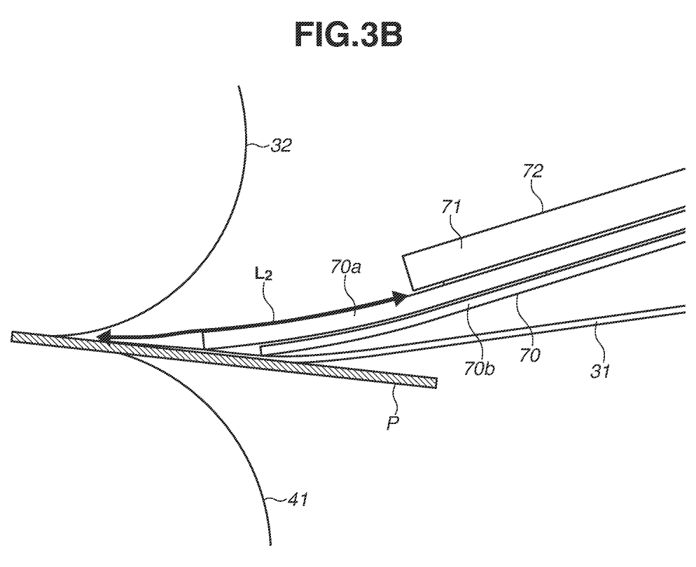

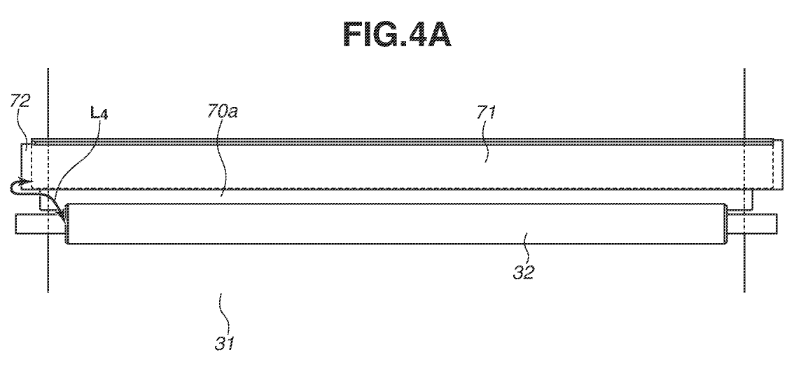

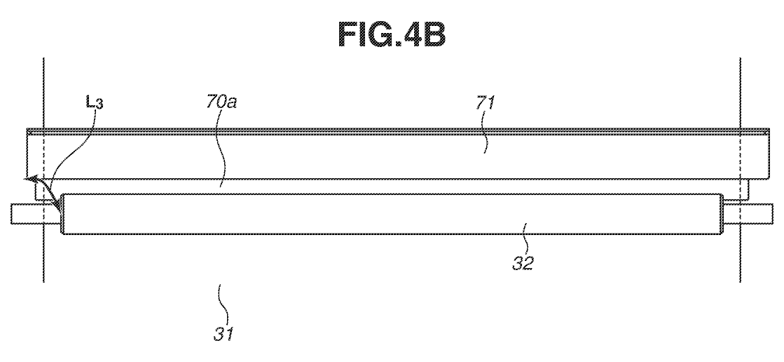

FIG. 3A is a schematic cross-sectional view of the secondary transfer unit including the insulating member 72 according to the present disclosure, FIG. 3B is a schematic cross-sectional view of a secondary transfer unit of a conventional configuration, FIG. 4A is a longitudinal schematic view of the secondary transfer unit including the insulating member 72 according to the present disclosure, and FIG. 4B is a schematic cross-sectional view of the secondary transfer unit of the conventional configuration.

Next, a configuration of the insulating member 72 will be described. In the present embodiment, as illustrated in FIG. 3A, the insulating member 72 is arranged between the backup member 70 and the backup member holding member 71 serving as a holding member of the backup member 70. The backup member holding member 71 is made of a metallic member. The insulating member 72 is configured to cover the downstream end of the backup member holding member 71 in the conveyance direction of the intermediate transfer belt 31. That is, the insulating member 72 is an insulating member (first insulating portion) that covers a first surface of the backup holding member 71 at least at the downstream end of the backup holding member 71 in the conveyance direction of the intermediate transfer belt 31. Furthermore, the insulating member 72 is an insulating sheet that includes an insulating member (second insulating portion) that is folded back from the first surface downstream of the backup holding member 71 in the conveyance direction of the intermediate transfer belt 31 and covers a second surface of the backup holding member 71. In the present embodiment, the insulating member 72 is made of a polyimide material with a thickness of 0.05 mm. In the present embodiment, when the secondary transfer high voltage is applied, a creepage distance between the secondary transfer unit and the backup member holding member 71 is L₁ = 28 [mm] (2 V [mm] where the high voltage capacity is V [kV]), as illustrated in FIG. 3A. Even under the condition that the secondary transfer high voltage in the present embodiment is 14 [kV], it is possible to prevent the secondary transfer high voltage from leaking to the backup member holding member 71. In the conventional configuration, the creepage distance between the secondary transfer unit and the backup member holding member 71 is L₂ < 28 [mm], as illustrated in FIG. 3B. Accordingly, under the condition that the secondary transfer high voltage is greater than 11 [kV], the secondary transfer high voltage may leak to the backup member holding member 71.

In the present embodiment, as illustrated in FIG. 4A, the insulating member 72 is arranged so as to extend beyond both ends of the backup member holding member 71 in a direction orthogonal to the transfer belt conveyance direction. That is, in the width direction of the intermediate transfer belt 31 orthogonal to the conveyance direction of the intermediate transfer belt 31, the insulating member 72 is longer than the backup holding member 71. In addition, in the width direction of the intermediate transfer belt 31 orthogonal to the conveyance direction of the intermediate transfer belt 31, both ends of the insulating member 72 are arranged outside both ends of the backup holding member 71. When the secondary transfer high voltage is applied, in the present embodiment, the creepage distance between the secondary transfer unit and the backup member holding member 71 is L₄ = 28 mm, as illustrated in FIG. 4A. That is, when the maximum applied voltage of the secondary transfer high voltage is V kV, the creepage distance is 2 V mm or more. That is, even under the condition that the secondary transfer high voltage is 14 kV in the present embodiment, it is possible to prevent the secondary transfer high voltage from leaking to the backup member holding member 71. In the conventional configuration, the creepage distance between the secondary transfer unit and the backup member holding member 71 in the longitudinal direction of the secondary transfer member is L₃ < 28 mm, as illustrated in FIG. 4B. Accordingly, under the condition that the secondary transfer high voltage is 14 kV, the secondary transfer high voltage may leak to the backup member holding member 71.

In the present embodiment, the insulating member 72 is made of a polyimide material with a thickness of 0.05 mm, but the insulating member 72 is not limited to this configuration and may be made of any material having insulating properties. Also, in the present embodiment, the creepage distance between the secondary transfer unit and the backup member holding member is set to 28 mm (2 V mm where the high voltage capacity is V kV), but the length of the creepage distance is not limited to this example.

In the present embodiment, a bias of the same polarity as the charge polarity of the toner of the toner image on the intermediate transfer belt 31 is applied to the inner secondary transfer roller 32 by the secondary transfer high-voltage power supply 38. The outer secondary transfer roller 41 is grounded to earth, thereby forming a transfer field in the secondary transfer unit. However, a bias of the polarity opposite to the charge polarity of the toner of the toner image on the intermediate transfer belt 31 may be applied to the outer secondary transfer roller 41 by the secondary transfer high-voltage power supply 38. The inner secondary transfer roller 32 may be grounded to earth, thereby forming a transfer field in the secondary transfer unit.

As described above, according to the present disclosure, arranging the insulating member so as to cover the downstream end of the backup member holding member in the conveyance direction of the intermediate transfer belt makes it possible to prevent leakage of the secondary transfer voltage from the secondary transfer unit to the backup member holding member. Furthermore, arranging the insulating member so as to extend beyond both ends of the backup member holding member in the direction orthogonal to the conveyance direction of the intermediate transfer belt makes it possible to prevent leakage of the secondary transfer voltage to both ends in the direction orthogonal to the conveyance direction of the intermediate transfer belt.

According to the present disclosure, it is possible to suppress leakage of the secondary transfer voltage from the secondary transfer unit to the backup member holding member.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims priority to and the benefit of Japanese Patent Application No. 2024-180802, filed October 16, 2024, which is hereby incorporated by reference herein in its entirety.

What is claimed is:

1. An image forming apparatus comprising:
an intermediate transfer belt onto which a toner image is to be transferred;
an inner roller configured to stretch the intermediate transfer belt;
an outer roller configured to sandwich the intermediate transfer belt between the outer roller and the inner roller to transfer the toner image formed on the intermediate transfer belt onto a recording medium;
a backup member configured to contact an inner surface of the intermediate transfer belt upstream of the inner roller in a conveyance direction of the intermediate transfer belt;
a holding member configured to hold the backup member such that a downstream end of the backup member is arranged downstream of an upstream end in the conveyance direction of the intermediate transfer belt and the downstream end of the backup member is in contact with the intermediate transfer belt; and
an insulating member configured to cover the downstream end of the holding member with respect to the conveyance direction of the intermediate transfer belt, and to cover the holding member from one end of the holding member to an other end in a width direction orthogonal to the conveyance direction.

2. The image forming apparatus according to claim 1, wherein the backup member is an insulating resin member.

3. The image forming apparatus according to claim 1, wherein the holding member is a metallic member configured as a ground.

4. The image forming apparatus according to claim 1, wherein the downstream end and the upstream end of the insulating member are extend beyond each end of the holding member in the width direction.

5. The image forming apparatus according to claim 1,
wherein the inner roller is configured in such a way that a transfer voltage is applied to the inner roller, and the outer roller is grounded.

6. The image forming apparatus according to claim 1, wherein a creepage distance between the inner roller and the holding member is 2 V [mm] or more where a maximum applied voltage from the application unit is V [kV].

7. The image forming apparatus according to claim 1, wherein the insulating member is folded back at a downstream of the holding member in the conveyance direction of the intermediate transfer belt.

8. The image forming apparatus according to claim 1, wherein the backup member is formed as a sheet.

9. The image forming apparatus according to claim 1, further comprising a transfer roller that is adjacent to the inner roller, upstream of the inner roller in the conveyance direction, and configured to stretch the intermediate transfer belt,
wherein the backup member is arranged downstream of the transfer roller in the conveyance direction.

10. An image forming apparatus comprising:
an intermediate transfer belt;
an inner roller;
an outer roller;
a backup member;
a holding member; and
an insulating member, wherein:
the outer roller and the inner roller are configured to sandwich the intermediate transfer belt therebetween,
the backup member is configured to contact a surface of the intermediate transfer belt upstream of the inner roller, in a transfer conveyance direction,
the holding member is configured to position a downstream end of the backup member,
the downstream end of the backup member is configured to contact the intermediate transfer belt, and
the insulating member covers the downstream end of the holding member in a width direction orthogonal to the conveyance direction.

11. The image forming apparatus of claim 10, wherein the inner roller is configured to stretch the intermediate transfer belt.

12. The image forming apparatus of claim 10, wherein the intermediate transfer belt is configured to receive a transfer of at least a part of a toner image, for transfer onto a recording medium.
